(19) United States
(12) Patent Application Publication
(10) Pub. No.: US 2026/0259004 A1
(43) Pub. Date: Sep. 3, 2026

(54) FIRING FURNACE

(71) Applicant: OROTIG S.P.A., Castlenuovo del Garda (IT)

(72) Inventors: Alberto GAGLIANO, Castlenuovo del Garda (IT); Tommaso ROMANELLI, Castlenuovo del Garda (IT); Giuliano ZERBATO, Castlenuovo del Garda (IT)

(21) Appl. No.: 19/163,942

(22) PCT Filed: Mar. 4, 2024
(86) PCT No.: PCT/IB2024/052051

§ 371 Date: Sep. 10, 2025

(30) Foreign Application Priority Data
Mar. 10, 2023 (IT) 102023000004590

(51) Int. Cl. F27B 9/16; F27B 17/00; F27D 3/00

(52) U.S. Cl. CPC F27B 9/16; F27B 17/0016; F27D 3/00; F27D 2003/0034

(57) ABSTRACT

A method is described of firing a casting cylinder inside a furnace, in which, to improve the firing uniformity, during firing the casting cylinder is moved inside the chamber to receive heat from a heating element, and is rotated about a movable axis which is moved within the chamber.

### TECHNICAL FIELD

The present invention concerns a firing furnace for casting cylinders (moulds), such as those which e.g. cooperate with a crucible such as crucible 28 of U.S. Pat. No. 5,685,360.

### BACKGROUND

Furnaces are known for firing casting molds made of refractory material. E.g. the utility model CN205641974U describes a rotary type electric furnace for cylinders made of refractory material. The furnace comprises a rotating base, a heating element arranged around the cylinders and a gear motor which rotates, via a belt, a rotating support on which the cylinders are placed. These furnaces have the disadvantage that the cylinders under firing always show the same side to the heat source (heating resistor 17), therefore the quality of the refractory material of the final mold is affected. On the contrary, to produce valuable objects, casting molding requires molds with well-reproducible and uniform characteristics. In particular, the refractory material that makes up the casting cylinder undergoes a thermal shock, due to a non-homogeneous expansion of the lining material because it is as if it were subjected to the action of a point-like thermal source from which the heat arrives from only one direction.

Therefore inside the same cylinder there are areas of refractory material which have undergone uneven firing temperatures, and which create on the surface of the metal casting differences in surface smoothness which can be substantial.

### SUMMARY

The object of the invention is to improve this state of the art.

In particular, the object of the invention is to improve the homogeneity of the heating of casting cylinders placed inside the furnace, thereby improving the construction quality of the cylinders and thus obtaining better final products.

These and other objectives, which will become clearer below, are achieved by what is defined in the attached claims, where the dependent claims define advantageous variants of the invention.

An aspect of the invention concerns a method for firing a casting cylinder within a firing chamber. To improve firing uniformity and make firing uniform across the entire mass of the casting cylinder, the casting cylinder is rotated about a movable axis, which moves or is movable within the chamber.

The advantage is that the material that makes up the casting cylinder no longer undergoes a thermal shock caused by the inhomogeneity of the heat received, but the heating is uniform across its entire volume. Then during the molding casting the cylinder will have a more homogeneous and regular expansion.

In a variant, the movable axis is the axis of the cylinder itself, so the cylinder rotates on itself about its own axis inside the firing chamber as such axis moves inside the firing chamber.

Alternatively or in combination, the movable axis may be an axis external to the cylinder about which the cylinder rotates like a satellite (i.e. the cylinder's own axis is movable to rotate about the external axis which in turn is also movable). In this case, the cylinder may rotate about its own axis or not.

With the options described above for the movable axis, further variations disclosed below are possible.

In a variant, the movable axis during firing is moved along a predefined path, e.g. is moved eccentrically along an imaginary circumference about a fixed central axis. The fixed central axis passes through the center of the circumference and is orthogonal to the lying plane of the circumference. The cylinder receives heat from a heating element, which e.g. radiates heat towards the circumference, and the casting cylinder is rotated about the fixed central axis and simultaneously is moved along the circumference (about the movable axis).

In a preferred variant, the movable axis is moved along the circumference and kept parallel to the fixed central axis. In this way it is obtained that the cylinder moves like a planet which, rotating on itself and/or about the external axis, also rotates around the sun, so the entire lateral surface of the cylinder is progressively exposed to the heat of the heating element. However, it is possible for example that the movable axis moves along the circumference remaining parallel to the plane of the circumference, and in particular always oriented in the same direction.

In a variant, the heating element radiates heat from the center of the circumference towards the outside of the circumference and/or from the outside of the circumference towards the center of the circumference.

To rotate the casting cylinder about the movable axis, a dedicated drive may be used or its motion along the circumference can be exploited.

In particular, the movement of the casting cylinder along the circumference and the rotation about the movable axis are independently controlled movements. Or, to simplify the furnace structure, the rotation of the casting cylinder about the movable axis is derived from or energized by the displacement of the casting cylinder along the circumference.

In a variant, the rotation motion of a casting cylinder about the movable axis is transmitted to another casting cylinder by mechanically coupling the two cylinders.

Another aspect of the invention concerns a furnace for firing a casting cylinder, comprising:
a firing chamber,
a heating element adapted to radiate heat inside the firing chamber towards the cylinder,
means or a device for rotating the casting cylinder within the firing chamber about a movable axis.

The definition and options for the axes in the above furnace are the same as in the method.

Preferably, for compactness, the furnace comprises means or a device for moving the movable axis inside the firing chamber. The driving means or the driving device for moving the movable axis could also be coupled if necessary to the furnace without permanently installing them on it.

Therefore, in a variant the furnace also comprises means or a device for moving the movable axis inside the firing chamber along a path, e.g. along said imaginary circumference around the fixed central axis. In a more preferred variant, wherein the movable axis does not coincide with the own axis of the cylinder but is external to the cylinder, the furnace comprises means for rotating the cylinder on itself while the own axis of the cylinder rotates about the movable axis.

In a variant, said means or device for rotating and/or the heating element and/or said means or device for moving are installed inside the firing chamber, to simplify the construction of the furnace.

In a variant, the heating element is configured to radiate heat from the center of the circumference towards the outside of the circumference and/or from the outside of the circumference towards the center of the circumference. In a variant, the heating element is configured to radiate heat from the center of the firing chamber towards the outer perimeter of the firing chamber and/or from the outer perimeter of the firing chamber towards the center of the firing chamber. In a variant, the heating element is configured to radiate heat towards said path.

In a variant, the means or device for moving comprises or is constituted by a table which is rotatable about a central axis (the circumference has its center on the fixed central axis), and adapted to support a plurality of cylinders. The advantage is to simultaneously move the axes of this plurality along the circumference. To rotate the rotatable table about the fixed central axis in a variant the furnace comprises a drive or an actuator (e.g. an electric motor), or a manual system.

In a variant, the furnace comprises, or the means or device for rotating the cylinder comprises or consists of, a rotatable support which is mounted inside the firing chamber,
adapted to support one or more casting cylinders, and
rotatable about the movable axis.

In a variant, preferred for compactness, the rotatable support is rotatably mounted on the rotatable table so that the movable axis of the support can rotate about the fixed central rotation axis of the table.

In a variant, on the rotatable table are mounted a plurality of rotatable supports, wherein the movable axes of the plurality of supports are placed equally angularly spaced on one or more imaginary concentric circumferences.

To rotate the rotatable support about the movable axis in a variant the furnace comprises a drive or an actuator (e.g. an electric motor), or a manual system. More preferably, the rotation of the rotatable table is exploited to also rotate the rotatable support, thereby saving a drive. For this purpose, an obstacle element adapted to meet a portion of the rotatable support, e.g. at each revolution of the rotatable table, is installed in the firing chamber and it is adapted to impart a thrust to such portion to rotate the casting support about the movable axis of the support.

In a more preferred variant of said portion, the rotatable support comprises a series of protruding elements or arms, e.g. linear and/or all equal and/or rigid, which are arranged sunburst-like around the movable axis and adapted to meet the obstacle element. The sunburst arrangement has e.g. center on the movable axis and/or said elements or arms extend outwards orthogonally to the movable axis. In particular, said arms or elements are arranged like the bisectors or diagonals of a regular polygon.

The obstacle element may be fixed or stationary in the firing chamber, or displaceable or movable, e.g. in turn moved by a drive or actuator. By displacing the position of the obstacle element over time, the cyclic rotation pattern of the casting cylinder about the secondary axis and its exposure to the heat of the heating element can be varied.

The obstacle element may be positioned at the center of the circumference and/or outside the circumference, and/or at the center of the firing chamber and/or on the external perimeter of the firing chamber.

In a variant, at least two rotatable supports are arranged so that their arms or protruding elements can touch and rotate arms or protruding elements of an adjacent rotatable support, so as to communicate the rotary motion of a rotatable support to another rotatable support.

In a variant, two or more rotatable supports are rotatably coupled through mutually engaging gears, so as to rotate such rotatable supports synchronously by transferring rotary motion from one support to the other through the gears.

To avoid the shielding of heat radiation among the casting cylinders, all or some of the rotatable supports are placed on the rotatable table so that along—or close to—a radius originating from the center of the rotatable table there is only one movable axis. Or the rotatable table is ideally divided into equal angular sectors, and each sector contains only one movable axis.

In the various aspects of the invention:
the casting cylinder is e.g. made out of a metal cylinder whose interior is filled with special coating material for the lost wax casting technique; or it is made of graphite or ceramic or in general of refractory material; and/or
the heating element is an electric resistor or an infrared ray emitter, but any thermal source can be used;
the casting cylinder has the shape of a glass or cup, or e.g. is formed of a body that defines a bottom and lateral containment walls which surround an opening towards the inside of the cylinder, and the axis of the cylinder intersects said bottom and passes through said opening;
said means for moving and/or said means for rotating are made with respective mechanisms, kinematic chains or actuators.

### BRIEF DESCRIPTION OF THE DRAWINGS

Further aspects and advantages of the present invention will appear better from the following detailed description of a preferred practical embodiment illustrated by way of example with reference to the attached drawings, in which:

FIG. 1 shows a vertical sectional view of a firing furnace;

FIG. 2 shows a side view of a detail of the furnace;

FIG. 3 shows a plan view of a detail of the furnace.

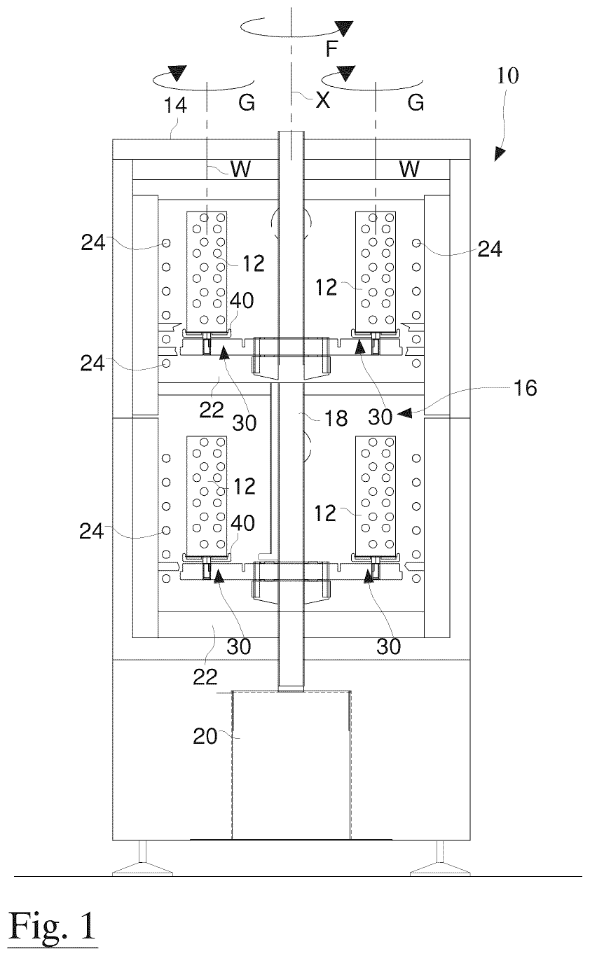

### DETAILED DESCRIPTION

In the drawings, same or similar parts or components have been designated with equal reference numbers. To avoid crowding the drawings, some repeated elements are not indicated by a number.

A furnace 10 for firing casting cylinders 12 comprises a casing 14 which defines a firing chamber 16. The firing chamber 16 is preferably adequately insulated so as not to disperse heat.

Inside the chamber 16 extends a vertical shaft 18, which can be rotated (see arrow F in FIG. 3) about its vertical X axis by a motor 20, preferably mounted outside the firing chamber 16 and more preferably as a component of the furnace 10.

The centers of one or more rotatable tables 22 arranged inside the firing chamber 16 at different heights are fixed to the shaft 18. The rotatable tables 22 are mounted orthogonally to the shaft 18 and such that the shaft 18 causes them to rotate about the fixed X axis.

A plurality of revolving plates 30 are pivoted on each rotatable table 22 so as to be able to rotate (see arrow G in FIG. 3) about a movable W axis, e.g. parallel to the X axis. Preferably the W axis coincides with the axis of the casting cylinder 12. Each revolving plate 30 can receive at least one casting cylinder 12 placed vertically (with the casting opening upwards or downwards).

The casting cylinders 12 are fired through the heat emitted e.g. by heating elements 24, e.g. electrical resistors, mounted e.g. on the side walls of the firing chamber 16. The heat generated by the heating elements 24 radiates from the perimeter of the rotatable tables 22 towards the X axis so as to hit all the casting cylinders 12 arranged on the rotatable tables 22.

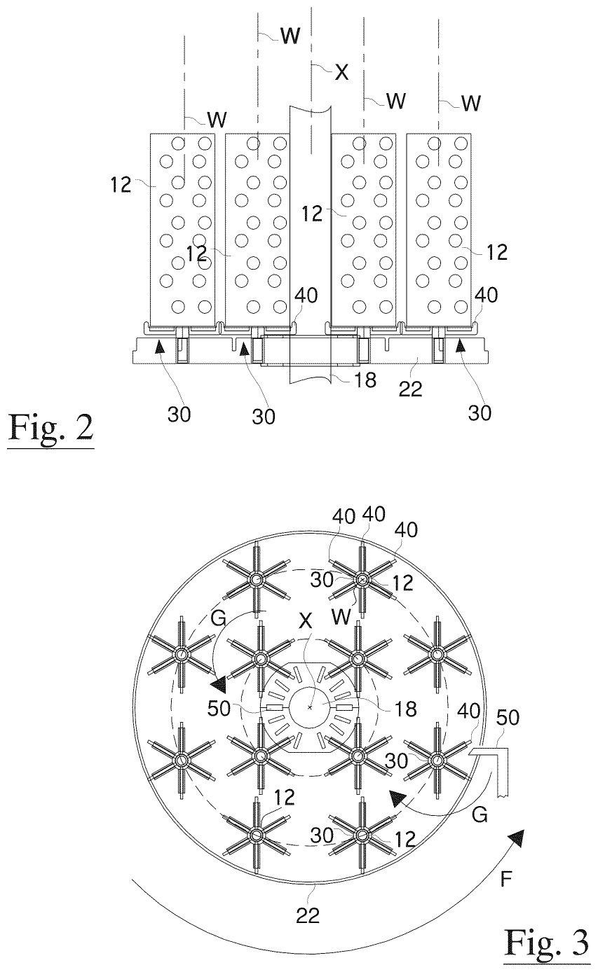

On each rotatable table 22 a plurality of revolving plates 30 may be mounted, and in particular as in FIG. 2: the W axes of the revolving plates 30 are equally spaced angularly on one or more imaginary concentric circumferences (two in the illustrated example, one external and one internal, drawn in dotted lines) having their center on the X axis.

Each revolving plate 30 may be set into rotation about the W axis by an independent motor, or the motor 20 can be exploited for this too. For this purpose, the revolving plates 30 have a series of rigid arms 40, e.g. linear and/or e.g. all equal, which form a sunburst-like pattern, which preferably has a center of polar symmetry on the W axis. The arms preferably extend outwards orthogonally to the W axis. In a variant, the rigid arms 40 are arranged like the bisectors or diagonals of a regular polygon. In the firing chamber 16 (see FIG. 3) there are installed obstacles 50 which are stationary with respect to the rotatable table 22 and positioned so that the free end of at least one rigid arm 40 of each revolving plate 30 can collide with one of them as it revolves about the X axis.

At each complete revolution of the rotatable table 22, such free end temporarily bumps against a stationary obstacle 50 and is pushed by it into rotation by a certain angle, e.g. less than 90 degrees. Consequently, both the relevant revolving plate 30 and the casting cylinder 12 which is on it rotate about the W axis by that angle. After a certain number of revolutions of the rotatable table 22, a complete revolution of each revolving plate 30 about the axis W is obtained, so that, rotation by rotation, the entire lateral surface of each casting cylinder 12 progressively passes closer to—and/or faces—the electrical resistors 24. The effect is that the casting cylinder 12 is fired in its entire mass more uniformly.

To rotate the casting cylinders 12 placed on the external circumference use is made for example of a stationary obstacle 50 mounted on the wall of the firing chamber 16. To rotate the casting cylinders 12 placed on the internal circumference (closest to the X axis) use is made for example of a stationary obstacle 50 mounted at the center of the firing chamber 16. It is also possible to design the rigid arms 40 so that the rigid arms 40 of a revolving plate 30 touch and rotate the rigid arms 40 of an adjacent revolving plate 30, i.e. the rigid arms 40 behave like meshing gears.

Alternatively or in combination, two or more revolving plates 30 may be provided with gears engaged with each other to rotate the revolving plates 30 synchronously. By varying the number of stationary obstacles 50 along a circumference, the number of rotations around the W axis can be programmed for each revolution of the rotatable table 22, hence the amount of heat absorbed by a lateral strip of each casting cylinder 12.

The stationary obstacles 50 acting on the revolving plates 30 of the external circumference cause a rotation of those revolving plates 30 in a sense opposite to the rotatable table 22; while the stationary obstacles 50 acting on the revolving plates 30 of the internal circumference cause a rotation of those revolving plates 30 in the same sense as the rotatable table 22. The sense of rotation of a revolving plate 30 depends on the radial position of the stationary obstacle 50 on the rotatable table 22 with respect to the W axis, and such position may be adjustable.

During firing, one or more obstacles 50 can be displaced to reverse the sense of rotation of a revolving plate 30. For this purpose, one or more obstacles 50 may be, for example, mounted in a movable manner inside the firing chamber 16, e.g. to be able to displace from the outside to the inside, or vice versa, of a circumference.

To facilitate uniform firing of each casting cylinder 12, the revolving plates 30 are preferably arranged so that one casting cylinder 12 does not shield the thermal irradiation of another casting cylinder 12. For this purpose, e.g. all or some of the revolving plates 30 are placed on the rotatable table 22 so that along—or close to—a radius originating from the center of the rotatable table 22 there is only one W axis. Or the rotatable table 22 is ideally divided into equal angular sectors, and each sector contains only one W axis.

Alternatively or in combination, the heating elements 24 may be installed at the center of one or each rotatable table 22.

1. Method of firing a casting cylinder inside a furnace, in which during firing the casting cylinder is moved inside the chamber to receive heat from a heating element,
wherein the casting cylinder is rotated about a movable axis which is moved within the chamber.

2. Method according to claim 1, wherein the cylinder is rotated about its own axis and such axis is moved within the chamber during firing.

3. Method according to claim 1, wherein the own axis of the cylinder is rotated about an axis external to the cylinder and this latter external axis is moved inside the chamber during firing.

4. Method according to claim 1, wherein the movable axis is moved along a circumference about a fixed central axis passing through the center of the circumference,
wherein the fixed central axis is orthogonal to the lying plane of the circumference and the movable axis is kept parallel to the fixed central axis.

5. Method according to claim 4, wherein the displacement of the movable axis along the circumference and the rotation of the cylinder about its own axis are independently controlled.

6. Method according to claim 4, wherein the rotation of the cylinder about its own axis is energized by the displacement of the movable axis along the circumference.

7. Furnace for firing a casting cylinder, comprising:
a firing chamber,
a heating element adapted to radiate heat towards the cylinder,
means for rotating the casting cylinder within the firing chamber about a movable axis which is movable or displaced within the firing chamber.

8. Furnace according to claim 7, comprising:
a rotatable support mounted inside the firing chamber and adapted to rotatably support one or more casting cylinders,
the rotatable support being rotatable about said movable axis.

9. Furnace according to claim 8, comprising means for moving the movable axis or the rotatable support along an imaginary circumference and about a fixed central axis passing through the center of the circumference.

10. Furnace according to claim 7, comprising a table which is rotatable about a fixed central axis and adapted to eccentrically support the movable axis or the rotatable support.

11. Furnace according to claim 8, comprising an obstacle element which is installed in the firing chamber and adapted for
meeting a portion of the rotatable support upon each turn of the rotatable table and
imparting a thrust to such portion to rotate the support about the movable axis.

12. Method according to claim 2, wherein the own axis of the cylinder is rotated about an axis external to the cylinder and this latter external axis is moved inside the chamber during firing.

13. Method according to claim 2, wherein the movable axis is moved along a circumference about a fixed central axis passing through the center of the circumference,
wherein the fixed central axis is orthogonal to the lying plane of the circumference and the movable axis is kept parallel to the fixed central axis.

14. Method according to claim 3, wherein the movable axis is moved along a circumference about a fixed central axis passing through the center of the circumference, wherein the fixed central axis is orthogonal to the lying plane of the circumference and the movable axis is kept parallel to the fixed central axis.

15. Method according to claim 13, wherein the displacement of the movable axis along the circumference and the rotation of the cylinder about its own axis are independently controlled.

16. Method according to claim 14, wherein the displacement of the movable axis along the circumference and the rotation of the cylinder about its own axis are independently controlled.

17. Method according to claim 13, wherein the rotation of the cylinder about its own axis is energized by the displacement of the movable axis along the circumference.

18. Method according to claim 14, wherein the rotation of the cylinder about its own axis is energized by the displacement of the movable axis along the circumference.
